(19) United States
(12) Patent Application Publication
(10) Pub. No.: US 2006/0280441 A1
(43) Pub. Date: Dec. 14, 2006

(54) Digital multimedia data recording/playback device and operating method thereof

(75) Inventors: Seung Woo Kum, Gyeongi-do (KR); Han Seung Chung, Seoul (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/445,161

(22) Filed: Jun. 2, 2006

(30) Foreign Application Priority Data
Jun. 2, 2005 (KR) 10-2005-0047185

(51) Int. Cl. H04N 5/91

(52) U.S. Cl. 386/94

(57) ABSTRACT

Provided are digital multimedia data recording/playback device and operation method thereof. The device includes a user interface, an HDD, and a system controller. The user interface selects a source apparatus having a recording medium on which multimedia data to be copied is stored, and a target apparatus for which a copy operation is performed and having a recording medium on which the multimedia data is to be stored, according to a user's selection. The HDD temporarily stores the multimedia data that has been selected as a copy object, and the system controller copies the multimedia data temporarily stored in the HDD to the selected target apparatus.

### BACKGROUND OF THE INVENTION

1. Field of the Invention

This document relates to a digital multimedia data recording/playback device and an operating method thereof.

2. Description of the Related Art

As various video home appliances are brought to the market recently, complex video home appliances (referred to as ‘digital multimedia data recording/playback devices’ hereinafter) that incorporate recording media having different formats into one device and uses the incorporated recording media are spot-lighted. These digital multimedia data recording/playback devices may include hard disk drives (HDDs), digital versatile disk (DVD) recorders, digital video home systems (DVHSs) provided to inside/outside of the digital multimedia data recording/playback devices. The digital multimedia data recording/playback devices may store broadcasting or input data from the outside on a recording medium using a HDD or a DVD recorder. Also, the digital multimedia data recording/playback devices may include various interfaces such as IEEE 1394 and integrated drive electronics (IDE), and may provide a rich image to a user through various external apparatuses such as DVHSs and camcorders.

Also, the digital multimedia data recording/playback devices have a function of copying a recorded image between recording media having different formats. For example, digital multimedia data recording/playback devices that have a DVD apparatus and a VHS apparatus can simply copy an image recorded on a recoding medium for a DVD onto a recording medium for a VHS, and vice versa.

The digital multimedia data recording/playback devices support two or more recording media having different formats that can store digital multimedia data, and provide a function of copying an image material or file between apparatuses to which different recording media are applied, respectively.

At this point, when a user intends to copy a predetermined DVD according to a related art method, a user performs a complicated process of directly selecting an image material contained in a DVD one by one, copying the selected image material on a hard disk drive (HDD), selecting the image material that has been copied to and stored in the HDD one by one, and copying the image material onto a DVD. That is, when ten image materials are contained in one DVD and a user intends to copy these ten materials, a user should perform total twenty times of copying operations where a user performs ten times of copying from a DVD used as a source recording medium to a HDD, and ten times of copying from the HDD to another DVD used as a target recording medium, which is cumbersome.

Also, digital signals of an image material delivered from the HDD are recovered into an image using a decoder, and then the recovered image is digitalized through an encoder and the digital image is copied onto a DVD used as a target medium. Accordingly, image quality reduction is generated, and a user should directly control 2×N times of copy operations in order to copy a title containing N recording materials because a user performs a copy operation on all titles contained in a DVD used as a source medium.

### SUMMARY OF THE INVENTION

Accordingly, the present invention is directed to a digital multimedia data recording/playback device and an operating method thereof that substantially obviate one or more of the problems due to limitations and disadvantages of the related art.

An object of the present invention is to provide a digital multimedia data recording/playback device and an operating method thereof, capable of more easily and efficiently generating a duplicate disk medium that is identical to a source disk medium.

To achieve these and other advantages and in accordance with the purpose of the present invention, as embodied and broadly described, there is provided a digital multimedia data recording/playback device including: a user interface for selecting a source apparatus having a recording medium on which multimedia data to be copied is stored, and a target apparatus on which a copy operation is performed and having a recording medium on which the multimedia data is to be stored, according to a user's selection; a hard disk drive (HDD) for temporarily storing the multimedia data selected as a copy object; and a system controller for copying the multimedia data temporarily stored in the HDD to the selected target apparatus.

According to another aspect of the present invention, there is provided an operating method for a digital multimedia data recording/playback device, the method including: selecting a source apparatus having a recording medium on which multimedia data to be copied is stored, and a target apparatus on which a copy operation is performed and having a recording medium on which the multimedia data is to be stored, according to a user's selection; temporarily storing the multimedia data selected as a copy object in a HDD; and copying the multimedia data temporarily stored in the HDD to the selected target apparatus.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a schematic block diagram of a digital multimedia data recording/playback device according to the present invention;

FIG. 2 is a view illustrating an initial user interface for disk copy according to the present invention;

FIG. 3 is a view illustrating a next user interface for disk copy according to the present invention; and

FIG. 4 is a flowchart illustrating a method of copying a disk in a digital multimedia data recording/playback device according to an embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

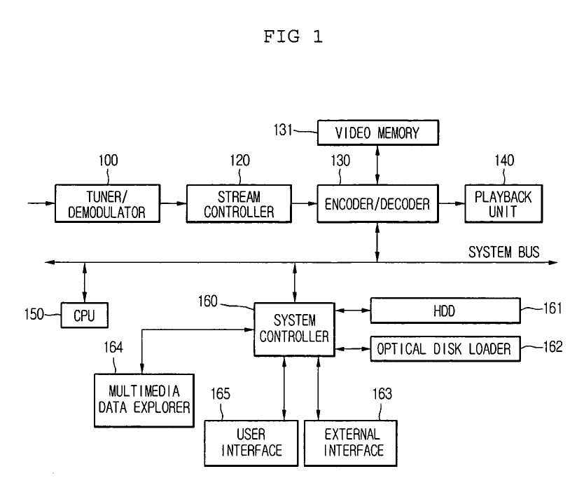

FIG. 1 is a schematic block diagram of a digital multimedia data recording/playback device according to the present invention.

Referring to FIG. 1, the digital multimedia data recording/playback device includes a tuner/demodulator 100, a stream controller 120, an encoder/decoder 130, a video memory 131, a playback unit 140, and a central processing unit (CPU) 150.

The tuner/demodulator 100 receives broadcasting signals from a service medium and outputs digital data. The stream controller 120 controls a transmission path of a data stream from the tuner/demodulator 100. The encoder/decoder 130 performs encoding or decoding on a data stream from the stream controller 120.

The video memory 131 may store a video stream, and the playback unit 140 may reproduce decoded digital data. The CPU 150 controls respective parts of a system in order to receive, reproduce, and record broadcasting.

Also, the digital multimedia data recording/playback device includes: a system controller 160 for controlling various apparatuses; an HDD 161 for storing data; an optical disk loader 162 for performing recording and playback on an input optical disk; an external interface 163 for connecting with an external media apparatus; a multimedia data explorer 164 for analyzing multimedia data stored in a source apparatus for each characteristic and providing the analyzed multimedia data when copying the multimedia data; and a user interface (UI) 165 for receiving a command from a user.

The digital multimedia data recording/playback device will be briefly described below.

The tuner/demodulator 100 converts broadcasting signals from a service medium into digital data streams and outputs the same under control of the CPU 150 through a system bus. The stream controller 120 stores the digital data streams on the HDD 161 and outputs the stored data streams through the encoder/decoder 130. At this point, the encoder/decoder 130 decodes the digital data streams and outputs the decoded digital data streams to the playback unit 140. Also, the encoder/decoder 130 may select the data streams, store the data streams on the video memory 131, read the stored data streams to decode the read data streams, and display the decoded data streams to the playback unit 140.

The system controller 160 delivers data between various peripheral devices and controls the various peripheral devices according to a user's command. The HDD 161, the optical disk loader 162, the external interface 163, and the user interface 165 may be connected to the system controller 160. The HDD 161 may have a large capacity memory in order to record data streams. The optical disk loader 162 may load a recording medium such as a DVD and a blu-ray disk (BD), read data recorded on a recording medium, and record data on a recording medium.

The external interface 163 includes a variety of interfaces. The external interface 163 particularly includes an interface having more than a predetermined speed (e.g., IEEE1394). A camcorder, a DVHS, a memory card may be connected to the external interface 163. Also, the external interface 163 may include interfaces such as IDE and enhanced IDE (EIDE).

Also, the user interface 165 not only receives broadcasting but also controls copying of data to be easily performed between recording media provided to an inside or outside of the device according to a user's command. For that purpose, when a multimedia data copy mode starts, interface means such as a source apparatus and target apparatus selection, multimedia data kind selection, multimedia data file selection, a copy start, copying., and copy completion may be provided. For example, an interface window for each step according to a copy mode is displayed on an OSD so that a user may select a relevant step using a key input part. Also, a graphic user interface (GUI) may be provided.

When a copy mode is performed, the multimedia data explorer 164 reads index information regarding multimedia data stored in the source apparatus, and classifies multimedia data using at least one of multimedia data's kind, a file size, a filename, and a generation date.

When a user intends to copy multimedia data stored on the HDD 161 to an optical disk, the multimedia explorer 164 analyzes only a characteristic selected by a user among the multimedia data stored on the HDD 161 and provides the analyzed characteristic on the OSD. Then, a user selects only a desired multimedia data file and requests copying of the file.

The optical disk loader 162 may be a DVD loader, for example, and reads information recorded on a loaded optical disk (e.g., a DVD and a BD) and stores the recorded information in an HDD 161, or encodes/decodes multimedia data using the encoder/decoder 130 and reproduces the multimedia data using the playback device 140.

Also, when a user selects a disk copy mode using the user interface 165 and intends to copy data recorded on an optical disk to other optical disk, a file recorded on a source optical disk loaded by the optical disk loader 162 is read, and temporarily stored in the HDD 161. After that, when an optical disk used as a target medium is loaded, the file stored on the HDD 161 is recorded on the optical disk used as the target medium. After that, the file stored on the HDD 161 may be copied onto the optical disk used as a target medium whenever necessary or an many times as necessary. That is, copying between optical disks may be conveniently performed using the HDD 161 for a temporary space.

Though the optical disk loader has been illustrated and described for convenience in the present invention, it is possible to perform an analog/digital conversion using a vide tape and then recording multimedia data on other recording medium, or recording on other recording medium using a digital VHS.

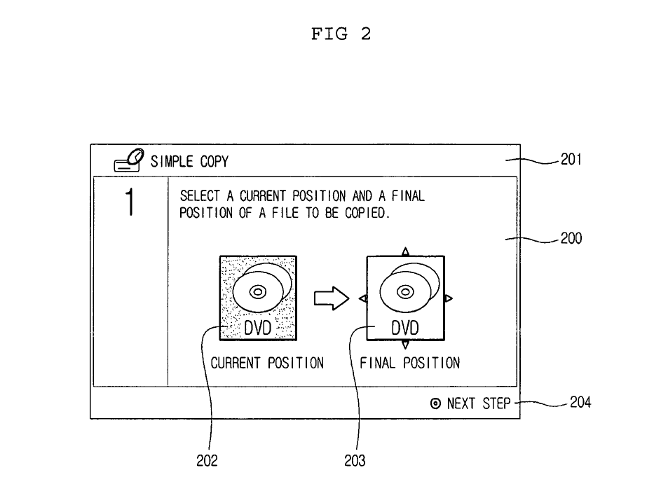

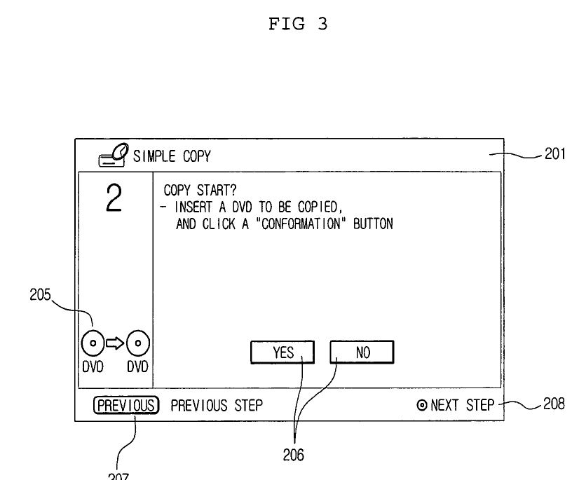

An example of disk copy in the digital multimedia data recording/playback device according to the present invention is illustrated in FIGS. 2 and 3.

Referring to FIG. 2, when a user selects a simple copy mode among copy modes using the user interface 165, a simple copy window 200 is realized on an OSD.

A copy object selection window 200 may be displayed on the OSD when a copy mode is selected. A source apparatus (source medium) item 211 that corresponds to a current position and a target apparatus (target medium) item 212 that corresponds to a final position are displayed on the copy object selection window 200. At this point, a user can select a source apparatus and a target apparatus using a direction key 213. Here, the source apparatus is an apparatus having a recording medium on which a copy object is stored, and the target apparatus is an apparatus having a recording medium on which the copy object is to be recorded.

Also, when a source apparatus and a target apparatus are selected, the next step is performed through a cursor control menu 206. Here, the source apparatus and the target apparatus may be selected from the HDD and the DVD loader mounted within the digital multimedia data recording/playback device, or may be selected from apparatuses connected to the outside.

When a user selects an optical disk for a current position, selects another optical disk for a final position, and selects a next step 204, a copy start message is displayed on the OSD as illustrated in FIG. 3. Also, when a user selects a copy confirmation button 206, entire data contained in the source optical disk is copied to the target optical disk.

Here, the current position and the final position are selected in FIG. 2, a copy path 205 from the current position to the final position (e.g., DVD→DVD) may be displayed on one side of the OSD as illustrated in FIG. 3. Also, position selection control 207 of a previous step, and a progression item to a next step 208 may be displayed on the other side of the OSD. User interfaces are displayed for each step in accordance with a progression of a copy mode as described above, so that a user may perform a copy operation more conveniently.

At this point, when a user operates the user interfaces only one time, copy from one optical disk to other optical disk is performed. Also, when a user intends to copy data to N optical disks and repeats operations of activating a copy start window and selecting a copy start button using a corresponding user interface, copying may be performed on the N optical disks.

The files recorded on the source optical disk are temporarily stored on the HDD upon input of the copy start button. When the temporal storing is completed, all the files are copied to the target optical disk. At this point, the temporarily stored files of the source optical disk may be stored in the HDD for a predetermined period of time.

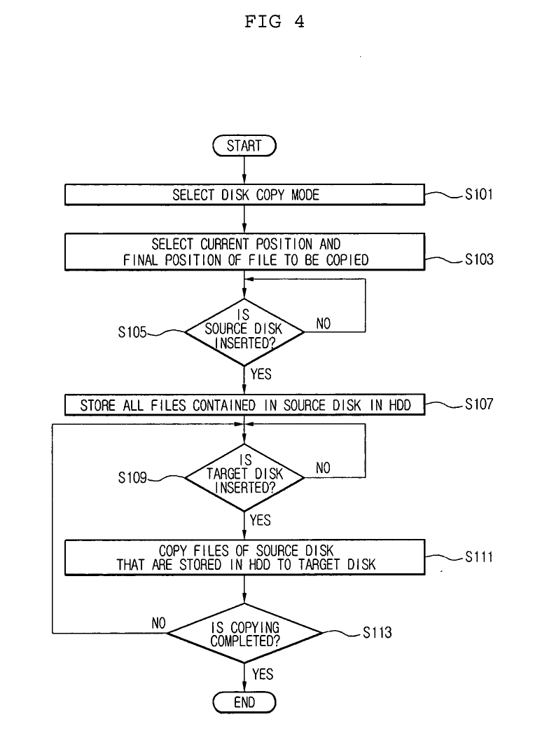

A method of copying a disk file in the digital multimedia data recording/playback device according to the present invention is illustrated in FIG. 4.

Referring to FIG. 4, when a user selects an optical disk copy mode (S101), a current position and a final position of a file to be copied are selected (S103). At this point, whether a source disk has been inserted is checked (S105). When the source disk has been inserted, all files contained in the source disk are temporarily stored in the HDD by a user copy start command (S107).

After that, when the temporary storing of all the files contained in the source disk is completed, whether the target optical disk has been inserted is checked (S109). At this point, when the target optical disk has been inserted, the files of the source disk that are stored in the HDD are copied to the target optical disk (S111).

After that, a user is questioned as to whether to continue copying (S113). The copy operation is ended or whether a new target optical disk has been inserted is checked. When the new target optical disk has been inserted, a process of copying all files of the source optical disk that are stored in the HDD to the new target optical disk is repeated. That is, once a copy operation is completed, copying to a plurality of target optical disks may be performed simply and efficiently.

Here, since multimedia data are simply copied as files from the HDD to the target optical disk, all information of the source optical disk can be substantially recorded. Also, since signals are not separately decoded or encoded in order to copy data from a source optical disk to a target optical disk, image quality reduction is not generated in the target optical disk.

The above-described copy method according to the present invention may be applied to various recording media such as DVD→HDD→DVD and camcorder→HDD→DVD.

According to another embodiment of the present invention, since a copy operation is performed independently of the decoder, copying between disks may be performed even when streams decoded using the decoder are reproduced by the playback unit.

As described above, the digital multimedia data recording/playback device according to the present invention uses the HDD as a temporary buffer for copying between disks, so that a user can perform copying more conveniently and perform copying regardless of disk capacity.

As described above, according to the present invention, a user can select a source apparatus and a target apparatus in order to perform a copy operation when copying multimedia data between the same kind of apparatuses or different apparatuses provided to inside/outside of the digital multimedia data recording/playback device. Also, according to the present invention, a user interface is established on an OSD to allow an easy access by a user. Also, the present invention allows a user to easily find an object to be copied by analyzing and exploring multimedia data stored in a source apparatus.

According to the present invention, a user simply selects a source apparatus and a target apparatus on which a copy operation is to be performed without driving the source apparatus to perform a described copy operation. That is, while a user reproduces multimedia data using an ‘A’ apparatus, a user can copy multimedia data stored on a recording medium of a ‘B’ apparatus onto a recording medium of a ‘C’ apparatus. The ‘A’, ‘B’, and ‘C’ apparatuses may be recording/playback apparatuses provided to inside/outside of the digital multimedia data recording/playback device according to the present invention. Also, the ‘A’ apparatus may be a digital broadcasting receiver of the digital multimedia data recording/playback device of the present invention, and the ‘B’ and ‘C’ apparatuses may be recording/playback apparatuses provided to inside/outside of the device.

According to a digital multimedia data recording/playback device and an operating method thereof of the present invention, it is possible to more easily and efficiently generate a duplicate disk medium that is identical to a source disk medium.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

What is claimed is:

1. A digital multimedia data recording/playback device comprising:
a user interface for selecting a source apparatus having a recording medium on which multimedia data to be copied is stored, and a target apparatus on which a copy operation is performed and having a recording medium on which the multimedia data is to be stored, according to a user's selection;
a hard disk drive (HDD) for temporarily storing the multimedia data selected as a copy object; and
a system controller for copying the multimedia data temporarily stored in the HDD to the selected target apparatus.

2. The device according to claim 1, further comprising a multimedia data explorer for exploring multimedia data information stored on the recording medium provided to the source apparatus and providing the explored multimedia data information.

3. The device according to claim 1, wherein the multimedia data comprise moving image data, still image data, and audio data.

4. The device according to claim 1, wherein the source apparatus and the target apparatus are provided to an inside of the device or connected to the outside of the device.

5. The device according to claim 1, wherein the source apparatus comprises a HDD (hard disk drive), an optical disk loader, a DVHS (digital video home system), and a memory card.

6. The device according to claim 1, wherein the target apparatus comprises a HDD (hard disk drive), an optical disk loader, a DVHS (digital video home system), and a memory card.

7. The device according to claim 1, wherein the user interface is realized using an OSD (on screen display).

8. The device according to claim 1, wherein the system controller performs the copy operation by a file unit without playback of multimedia data when performing the copy operation on the multimedia data.

9. The device according to claim 1, further comprising an external interface for connecting with an external apparatus.

10. The device according to claim 9, wherein the external interface comprises IEEE1394, IDE (Integrated Drive Electronics), and EIDE (Enhanced Integrated Drive Electronics).

11. An operating method for a digital multimedia data recording/playback device, the method comprising:
selecting a source apparatus having a recording medium on which multimedia data to be copied is stored, and a target apparatus on which a copy operation is performed and having a recording medium on which the multimedia data is to be stored, according to a user's selection;
temporarily storing the multimedia data selected as a copy object in a HDD; and
copying the multimedia data temporarily stored in the HDD to the selected target apparatus.

12. The method according to claim 11, further comprising, after the selecting of the source apparatus and the target apparatus according to the user's selection:
exploring multimedia data information stored on the recording medium provided to the source apparatus; and
providing the explored multimedia data information.

13. The method according to claim 12, wherein the user selects at least one multimedia data to be copied with reference to the multimedia data information.

14. The method according to claim 11, wherein the multimedia data comprise moving image data, still image data, and audio data.

15. The method according to claim 11, wherein the source apparatus and the target apparatus are provided to an inside of the device or connected to the outside of the device.

16. The method according to claim 11, wherein the selecting of the source apparatus and the target apparatus comprises selecting the source apparatus and the target apparatus using a user interface realized as an OSD.

17. The method according to claim 11, wherein the copying of the multimedia data comprises performing the copying by a file unit without playback of the multimedia data.

18. The method according to claim 11, further comprising, after the copying of the multimedia data:
selecting a new target apparatus on which copying is to be performed; and
copying the multimedia data to the selected target apparatus.
